(19) United States
(12) Patent Application Publication
(10) Pub. No.: US 2008/0042341 A1
(43) Pub. Date: Feb. 21, 2008

(54) Apparatus for Opening and Pivoting a Turner Gripper in a Sheet Processing Machine and Printing Press Having the Apparatus

(75) Inventors: Thomas Schmidt, Eppelheim (DE); Karl-Heinz Helmstadter, Heidelberg (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 11/839,951

(22) Filed: Aug. 16, 2007

(30) Foreign Application Priority Data
Aug. 16, 2006 (DE) DE102006038139.4

(51) Int. Cl. B41F 21/10; B41F 21/00; B41F 21/04

(52) U.S. Cl. 271/277; 271/264

(57) ABSTRACT

An apparatus for opening and closing a gripper, in particular a tongs-type gripper in a sheet processing machine, includes a radial cam for controlling a pivoting movement and an axial cam for controlling opening and closing movements of the gripper independently thereof, during a turning operation. A sheet-fed printing press having the apparatus is also provided.

### CROSS-REFERENCE TO RELATED APPLICATION

This application claims the priority, under 35 U.S.C. § 119, of German Application DE 10 2006 038 139.4, filed Aug. 16, 2006; the prior application is herewith incorporated by reference in its entirety.

### BACKGROUND OF THE INVENTION

### Field of the Invention

The invention relates to a turner gripper system in a sheet processing machine, in particular a printing press, in which the turner gripper system is disposed on a turning drum. The invention also relates to a sheet-fed printing press having the apparatus.

Such a turner gripper system is known, for example, from German Patent DE 24 14 998, corresponding to U.S. Pat. No. 4,101,122. That turner gripper system has a number of tongs-type grippers each including a rigid gripper and a sprung gripper. In recto or front side printing operation, the rigid gripper forms a gripper pad. In turning or perfecting printing operation, the rigid gripper is pivoted by a cam roller controller in the cycle of the sheet processing machine. The sprung gripper is likewise pivoted in the cycle of the machine by a second cam roller controller. In turning operation, the pivoting movements of the rigid and sprung grippers are in phase, as a result of which a sheet which is to be turned can be held. In order to open the turner gripper, the rigid gripper and the sprung gripper are moved relative to one another.

Due to long force paths, the influence of the elasticity of the gripper system together with a gripper control mechanism which is provided, has proven problematical. In that case, the force paths extend from a gripper tip over a gripper shaft, pinions and tooth segments as far as the control cam. The sum of the deformations of the individual components has a massive effect on excess pressure and the position of the rigid gripper. There is therefore a direct influence on the holding force as well as an indirect influence on the print quality.

### SUMMARY OF THE INVENTION

It is accordingly an object of the invention to provide an apparatus for opening and pivoting a turner gripper in a sheet processing machine and a printing press having the apparatus, which overcome the hereinafore-mentioned disadvantages of the heretofore-known devices of this general type and which can be adjusted simply.

With the foregoing and other objects in view there is provided, in accordance with the invention, in a sheet processing machine having a turner gripper system with grippers, the improvement comprising an apparatus for opening and pivoting the turner gripper system. The apparatus actuates a pivoting movement of the turner gripper system independently of an opening movement of the grippers.

It is a particular advantage of the invention that a common pivoting movement of the rigid gripper and the sprung gripper is controlled by a single cam controller and the gripper opening movement is controlled independently of the turner gripper controller.

As a result of this measure, the pivoting movement can be adjusted independently of the gripper opening movement.

In accordance with another, particularly advantageous embodiment of the invention, an axially displaceable pin engages in a first oblique groove in the gripper tube and at the same time in a second oblique groove in the gripper shaft. The second oblique groove is disposed at an angle relative to the first oblique groove. An axial displacement of the pin results in a relative pivoting movement of the gripper shaft with respect to the gripper tube and therefore controls opening or closing of the turner gripper.

In accordance with a further embodiment of the invention, an axially displaceable wedge comes into contact with a wedge face on the gripper tube and a wedge face disposed at an angle relative thereto on the gripper shaft, and the gripper tube and the gripper shaft are pivoted relative to one another. A pressure spring, in particular a torsion bar spring, ensures the gripper force in both embodiments.

With the objects of the invention in view, there is concomitantly provided a sheet-fed printing press, comprising an apparatus according to the invention.

Other features which are considered as characteristic for the invention are set forth in the appended claims.

Although the invention is illustrated and described herein as embodied in an apparatus for opening and pivoting a turner gripper in a sheet processing machine and a printing press having the apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a sheet processing machine;

FIG. 2 is a fragmentary, enlarged, partly broken-away and partly sectional plan view of a turning drum having a gripper control system according to a first exemplary embodiment of the invention; and

FIG. 3 is a fragmentary, further-enlarged, partly sectional view of a gripper opening and closing system according to a second exemplary embodiment of the invention.

### DETAILED DESCRIPTION OF THE INVENTION

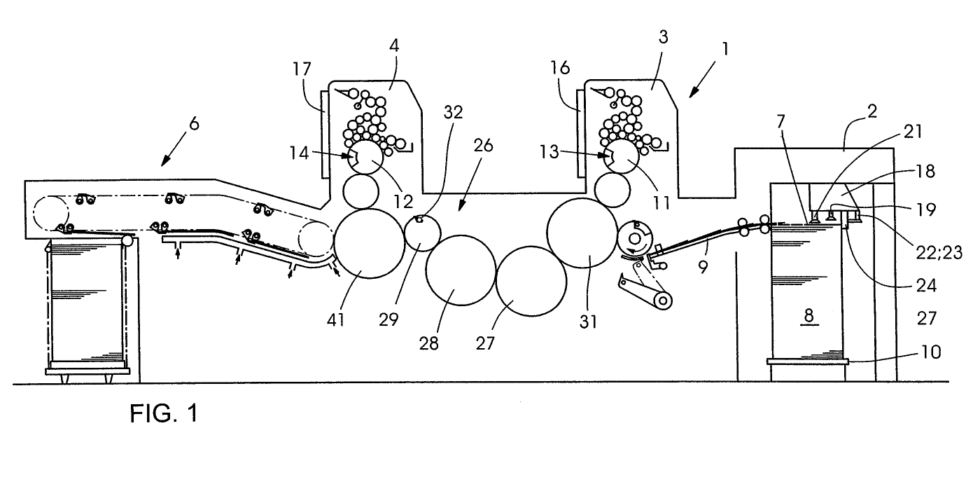

Referring now to the figures of the drawings in detail and first, particularly, to FIG. 1 thereof, there is seen a machine, for example a printing press 1, for processing sheets 7. The printing press 1 has a feeder 2, at least one printing unit 3, 4 and a delivery 6. The sheets 7 are removed from a sheet stack 8 and are fed individually or in an overlapped manner to the printing units 3 and 4 over a feed table 9. The printing units 3 and 4 each include a plate cylinder 11, 12, in a known manner. The plate cylinders 11 and 12 each have an apparatus 13, 14 for fastening flexible printing plates. Moreover, each plate cylinder 11, 12 is assigned an apparatus 16, 17 for semiautomatic or completely automatic printing plate changing.

The sheet stack 8 lies on a stack board 10 which can be raised in a controlled manner. The sheets 7 are removed from the upper side of the sheet stack 8 through the use of what is known as a suction head 18 which has, inter alia, a number of lifting and dragging suckers 19, 21 for separation of the sheets 7. Moreover, blowing devices 22 are provided for loosening the upper sheet layers, and sensing elements 23 are provided for tracking of the stack. A number of lateral and rear stops 24 are provided for aligning the sheet stack 8, in particular the upper sheets 7 of the sheet stack 8.

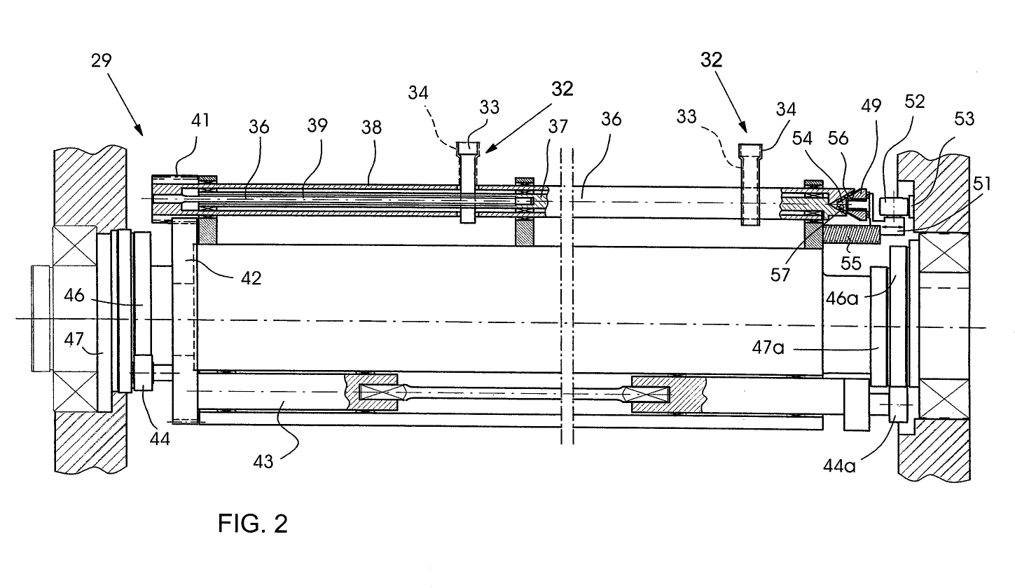

A three drum turning or perfecting device 26, including a transfer drum 27, a storage drum 28 and a turning drum 29, is provided between two impression cylinders 31 and 41. The turning drum 29 has what is known as a tongs-type or pincer gripper system 32 for turning the sheets in verso or perfecting printing operation. The other cylinders, which guide sheets, each have two gripper systems for sheet transport. The tongs-type gripper system 32, as is seen in FIG. 2, includes at least one rigid gripper 33 which forms a gripper pad in recto or front-side printing operation and a sprung gripper 34 which forms a gripper finger in recto or front-side printing operation. Both in verso printing operation and in recto printing operation, the grippers 33 and 34 can be pivoted about a common axis 36. The grippers 33 are seated on a gripper shaft 37 which is enclosed coaxially by a gripper tube 38. The grippers 34 are seated on the gripper tube 38. A torsion bar spring 39 connects the gripper tube 38 to the gripper shaft 37. A drive pinion 41, which is in toothed engagement with a tooth segment 42, is seated fixedly in terms of rotation on a first end of the gripper tube 38. The tooth segment 42 has a shaft 43, through the use of which it is mounted pivotably on the turning drum 29. A control roller 44, which is mounted rotatably on the tooth segment 42, lies opposite the shaft 43 in an offset manner. During recto printing operation, the control roller 44 is in operative contact with a first control cam 46. For verso printing operation, the control roller 44 is disposed in such a way that it can be brought into operative contact with a second control cam 47. The control roller 44 is assigned a control roller 44a on the opposite side of the turning drum 29. The control cams 46, 47 are assigned control cams 46a and 47a in a corresponding manner on the opposite side.

The control cams 47, 47a control the pivoting movement of the gripper system 32 during turning operation. The control cams 46, 46a control the pivoting movement during recto printing operation.

Opening and closing of the gripper system 32, independently of the pivoting movement, is controlled by an independent switching element 49, which can be actuated by the control cams 46, 47.

The switching element 49 is disposed in a guide 51 on the turning drum 29, on a side which lies opposite the pinion 41, in such a way that it can be displaced axially counter to the force of a compression spring 55. A control roller 52, which is disposed rotatably on the switching element 49, is in operative contact with a stationary axial cam 53.

The adjusting element 49 has a wedge-shaped tip 54 which is in operative contact with a first inclined slope 56 of the gripper tube 38 and at the same time with a second inclined slope 57 of the gripper shaft 37. The wedge-shaped tip 54 is formed, for example, from a tube which is severed diagonally or obliquely.

In order to open the gripper system 32, the gripper tube 38 and the gripper shaft 37 are pivoted with respect to one another about the common axis 36. For this purpose, the wedge-shaped switching element 49 is pushed axially with its tip 54 onto the inclined slopes 56, 57. As a result, the gripper tube 38 and the gripper shaft 37 pivot counter to the force of the torsion bar spring 39.

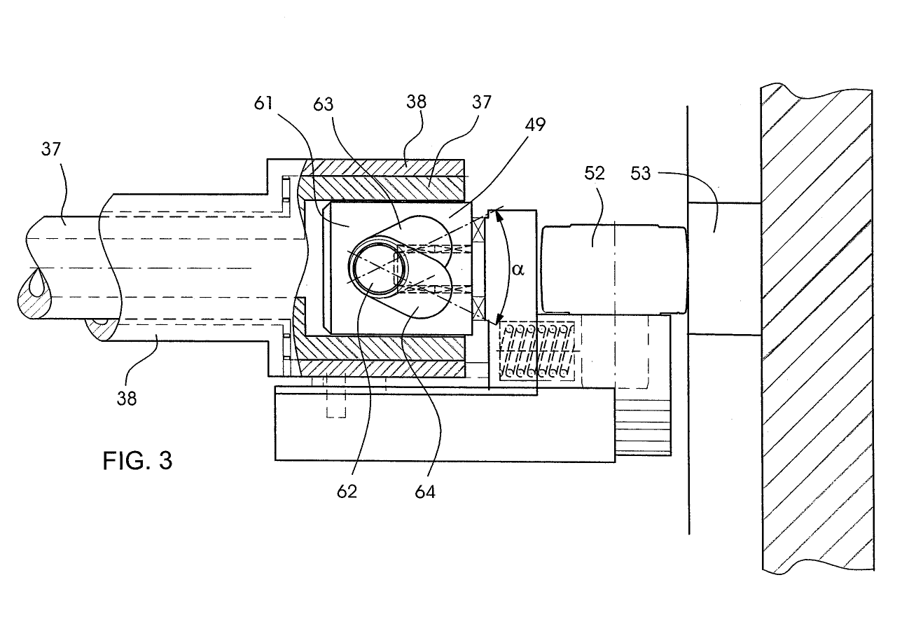

In a second exemplary embodiment according to FIG. 3, the switching element 49 is configured as a cylinder body 61 having a radially outwardly pointing pin 62 which engages in each case into an obliquely disposed groove 63 of the gripper tube 38 and into a groove 64 of the gripper shaft 37. The groove 64 extends obliquely and is disposed at an angle α with respect to the groove 63.

If the pin 62 is displaced axially, the gripper tube 38 and the gripper shaft 37 are pivoted with respect to one another as a result of the engagement of the pin 62 in the control grooves 63, 64, and the grippers 33, 34, which are seated in each case on the gripper tube 38 or on the gripper shaft 37, are therefore opened independently of the pivoting movement.

The axial cam 53 for actuating the switching element 49, and therefore for controlling the gripper opening times, is disposed in such a way that it can be set for changeover from recto printing to recto and verso printing, that is to say the axial cam 53 is either mounted rotatably on the side frame or a part of the cam 53 can be folded up in order to extend the gripper opening times in verso printing operation.

1. In a sheet processing machine having a turner gripper system with grippers, the improvement comprising:
an apparatus for opening and pivoting the turner gripper system, said apparatus actuating a pivoting movement of the turner gripper system independently of an opening movement of the grippers.

2. The apparatus according to claim 1, which further comprises:
a radial cam controller for producing said pivoting movement of the turner gripper system; and
an axial cam controller for producing said opening movement of the grippers.

3. The apparatus according to claim 1, wherein said axial cam controller has an axially movable switching element.

4. The apparatus according to claim 3, which further comprises:
a turning drum having a guide;
said switching element being mounted displaceably in said guide.

5. The apparatus according to claim 3, wherein said switching element has a wedge-shaped tip.

6. The apparatus according to claim 3, wherein said switching element has a radially outwardly pointing pin.

7. The apparatus according to claim 5, wherein:
the gripper system has obliquely disposed abutments; and
said switching element can be brought into contact with said obliquely disposed abutments.

8. The apparatus according to claim 6, wherein:
the gripper system has obliquely disposed abutments; and
said switching element can be brought into contact with said obliquely disposed abutments.

9. The apparatus according to claim 8, wherein said abutments are obliquely formed edges or faces respectively disposed on a gripper tube and a gripper shaft.

10. The apparatus according to claim 9, wherein said abutments are respective grooves obliquely formed in a gripper tube and a gripper shaft.

11. The apparatus according to claim 2, wherein said axial cam controller has an axial cam to be adjusted from recto printing to recto and verso printing.

12. A sheet-fed printing press, comprising an apparatus according to claim 1.
